(19) United States
(12) Patent Application Publication
(10) Pub. No.: US 2015/0136317 A1
(43) Pub. Date: May 21, 2015

(54) DOUBLE-SIDED ADHESIVE TAPE AND ADHESION METHOD USING DOUBLE-SIDED ADHESIVE TAPE

(71) Applicants: Kosaku Yamada, Hiroshima (JP); Hirofumi Murakami, Hiroshima (JP); Kazuya Fujita, Hiroshima (JP)

(72) Inventors: Kosaku Yamada, Hiroshima (JP); Hirofumi Murakami, Hiroshima (JP); Kazuya Fujita, Hiroshima (JP)

(73) Assignee: HAYAKAWA RUBBER CO., LTD., Hiroshima (JP)

(21) Appl. No.: 14/401,073

(22) PCT Filed: Jun. 28, 2012
(86) PCT No.: PCT/JP2012/004203

§ 371 Date: Nov. 13, 2014

(51) Int. Cl. C09J 7/02; B29C 65/50; B29C 65/14

(52) U.S. Cl. CPC C09J 7/02; B29C 65/1403; B29C 65/5021; B29C 65/5057; C09J 7/0217; C09J 2201/128; C09J 2201/606; C09J 2433/00
USPC 156/272.8; 156/60; 428/214

(57) ABSTRACT

A double-sided adhesive tape (1) having adhesive layers (3, 4) comprising an adhesive composition, provided on both surfaces of a base material (2). The adhesive composition is a thermoplastic elastomer-based adhesive or an acrylic-based adhesive. The thickness of the adhesive layers (3, 4) is set to at least 70 μm. The base material (2) is a solid film. The tensile breaking strength of the base material (2) is set to at least 80 MPa.

### CROSS REFERENCE TO RELATED APPLICATIONS

This application is a national stage application, filed under 35 U.S.C. §371, of International Application No. PCT/JP2012/004203, filed Jun. 28, 2012, the contents of which as are hereby incorporated by reference in their entirety.

### BACKGROUND

1. Technical Field

The present invention relates to double-sided adhesive tapes used to adhere various members, and adhesion methods using the double-sided adhesive tapes.

2. Description of Related Art

In some cases, double-sided adhesive tapes have been conventionally used to adhere, for example, members forming a flat panel display, an electric household appliance, an industrial electrical product, or any other product, members forming a household appliance, or members forming a writing material. The term “adhere” will now be used also in a situation where such members are temporarily adhered.

A double-sided adhesive tape of this type includes a substrate having surfaces on each of which an adhesive composition is provided as described in, for example, Japanese Unexamined Patent Publication No. H07-18229 and Japanese Unexamined Patent Publication No. 2010-260880. A substrate of a double-sided adhesive tape in each of these two Japanese Patent Publications is a foam.

### BRIEF SUMMARY

A bonding surface of a target member to be adhered may be uneven. Even if a double-sided adhesive tape is bonded to such a bonding surface, a portion of the bonding surface to which the double-sided adhesive tape can be effectively adhered and which has a sufficiently large area cannot be ensured. This may reduce the adhesive strength, and may cause water to reach the bonding surface or to leak in a situation where a high degree of water tightness is required.

Furthermore, to discard or recycle the target member, the double-sided adhesive tape needs to be separated. However, in the case of using a substrate made of a foam as in the double-sided adhesive tape of each of PATENT DOCUMENTS 1 and 2, when a double-sided adhesive tape is pulled so as to be removed, the substrate ruptures, and the double-sided adhesive tape tears somewhere. This tear makes it difficult to remove the double-sided adhesive tape.

It is therefore an object of the present invention to obtain an adequate adhesive strength to ensure a necessary degree of water tightness even if a bonding surface of a target member is uneven, and to prevent a tear in a double-sided adhesive tape and facilitate removing the double-sided adhesive tape when the double-sided adhesive tape needs to be separated.

In order to achieve the object, in the present invention, increasing the thicknesses of adhesive layers made of an adhesive composition allows the adhesive layers to be deformed while following bonding surfaces of target members, and can reduce the stress generated in the adhesive layers when a force is applied to the adhesive layers. Furthermore, using a solid film as a substrate improves the tensile breaking strength.

According to a first aspect of the invention, a double-sided adhesive tape includes: a substrate having surfaces on each of which an adhesive layer made of an adhesive composition is provided. The adhesive composition is a thermoplastic elastomer adhesive or an acrylic adhesive, a thickness of the adhesive layer is set to greater than or equal to 70 μm, the substrate is a solid film, and a tensile breaking strength of the substrate is set to greater than or equal to 80 MPa.

In this configuration, the thickness of the adhesive layer is greater than or equal to 70 μm. Thus, even if bonding surfaces of target members are uneven to some extent, the adhesive layers are deformed along the bonding surfaces to follow the bonding surfaces. This ensures that a portion of each bonding surface to which the double-sided adhesive tape can be effectively adhered has a sufficiently large area, and improves the adhesive strength. Furthermore, the contact between water and the bonding surfaces or leakage of water is reduced when a high degree of water tightness is required.

Since the thickness of the adhesive layer is greater than or equal to 70 μm, stress generated in the adhesive layer by the force applied to the double-sided adhesive tape after adhesion of the target members is easily dispersed and reduced as compared with when the thickness of the adhesive layer is less than 70 μm. This allows maintenance of high adhesive strength.

Furthermore, the tensile strength of the substrate is greater than or equal to 80 MPa, and when the double-sided adhesive tape is pulled and removed to separate the target members from each other, the double-sided adhesive tape, therefore, does not tear somewhere.

According to a second aspect of the invention, in the first aspect of the invention, a laser absorbent may be mixed into at least either the adhesive layers or the substrate, and the adhesive layers may be softened or melted by heat.

In this configuration, in the case of mixing the laser absorbent into the adhesive layers, when the double-sided adhesive tape is irradiated with laser beams, the laser beams are absorbed by the laser absorbent of each adhesive layer to heat the adhesive layer. Thus, the adhesive layers are softened or melted, thereby increasing the adhesion of the adhesive layers to the bonding surfaces and further improving the adhesive strength.

Alternatively, in the case of mixing the laser absorbent into the substrate, when the double-sided adhesive tape is irradiated with laser beams, the laser beams are absorbed by the laser absorbent of the substrate, and the substrate generates heat. The heat from the substrate is transferred to the adhesive layers, and the adhesive layers are heated. This further improves the adhesive strength.

Furthermore, since the solid film is used as the substrate, the thermal conductivity of the substrate is higher than when a foam is used as the substrate as in the conventional art, and heat generated by laser beams is easily transferred to each adhesive layer.

According to a third aspect of the invention, a method for adhering first and second members together using a double-sided adhesive tape including a substrate having surfaces on each of which an adhesive layer made of an adhesive composition is provided includes: using a thermoplastic elastomer adhesive or an acrylic adhesive as the adhesive composition, setting a thickness of the adhesive layer to greater than or equal to 70 μm, using a solid film as the substrate, and setting a tensile breaking strength of the substrate to greater than or equal to 80 MPa; and bonding one of the adhesive layers of the double-sided adhesive tape to a bonding surface of the first member, and bonding the other one of the adhesive layers to a bonding surface of the second member.

In this configuration, the thickness of each adhesive layer is greater than or equal to 70 μm. Thus, even if bonding surfaces of the first and second members are uneven to some extent, the adhesive layers are deformed along the bonding surfaces to follow the bonding surfaces. This ensures that a portion of each bonding surface to which the double-sided adhesive tape can be effectively adhered has a sufficiently large area, and improves the adhesive strength. Furthermore, the contact between water and the bonding surface or leakage of water is reduced when a high degree of water tightness between the first and second members is required.

Since the thickness of each adhesive layer is greater than or equal to 70 μm, stress generated in the adhesive layer by the force applied to the double-sided adhesive tape after adhesion of the first and second members is easily dispersed and reduced. This allows maintenance of high adhesive strength.

Furthermore, the tensile strength of the substrate is greater than or equal to 80 MPa, and when the double-sided adhesive tape is pulled and removed to separate the first and second members from each other, the double-sided adhesive tape, therefore, does not tear somewhere.

According to a fourth aspect of the invention, in the third aspect of the invention, a laser absorbent may be mixed into at least either the adhesive layers or the substrate, the adhesive layers may be softened or melted by heat, the double-sided adhesive tape may be irradiated with laser beams to soften or melt the adhesive layers so that the first and second members are adhered together.

In this configuration, softening or melting the adhesive layer with laser beams can further improve the adhesive strength. Furthermore, using the solid film as the substrate increases the thermal conductivity of the substrate, and heat generated by laser beams is, therefore, easily transferred to each adhesive layer.

According to a fifth aspect of the invention, in the fourth aspect of the invention, the first member may be transmissive to laser beams, and laser beams may be applied through the first member toward the double-sided adhesive tape.

In this configuration, laser beams pass through the first member, reaches the double-sided adhesive tape, and are absorbed by the laser absorbent of the double-sided adhesive tape. This can ensure that the adhesive layer is softened or melted.

According to a sixth aspect of the invention, in the third aspect of the invention, the second member may be non-transmissive to laser beams, and laser beams may be applied through the second member toward the double-sided adhesive tape.

In this configuration, the second member is heated by the laser beams. Since the double-sided adhesive tape is bonded to the second member, heat of the second member is transferred to the double-sided adhesive tape. The adhesive layers of the double-sided adhesive tape are heated so as to be softened or melted.

According to the first aspect of the invention, the thickness of the adhesive layer is greater than or equal to 70 μm. Thus, even if the bonding surfaces are uneven, an adequate adhesive strength is obtained, and a necessary degree of water tightness can be ensured. Furthermore, the substrate is made of the solid film, and the tensile breaking strength of the substrate is greater than or equal to 80 MPa. This can prevent the double-sided adhesive tape from tearing somewhere when separation of the double-sided adhesive tape is required, and can facilitate removing the double-sided adhesive tape.

According to the second aspect of the invention, the laser absorbent is mixed into at least either the adhesive layers or the substrate, and the adhesive layers are softened or melted by heat. This can further improve the adhesive strength. Furthermore, using the solid film as the substrate increases the thermal conductivity of the substrate, and heat generated by laser beams is easily transferred to both of the adhesive layers. Thus, the energy of the laser beams can be effectively utilized to soften or melt the adhesive layers.

According to the third aspect of the invention, similarly to the first aspect of the invention, even if the bonding surfaces are uneven, an adequate adhesive strength is obtained, and a necessary degree of water tightness can be ensured. Furthermore, the double-sided adhesive tape is prevented from tearing somewhere when separation of the double-sided adhesive tape is required, and the double-sided adhesive tape can be easily removed.

According to the fourth aspect of the invention, similarly to the second aspect of the invention, the adhesive strength can be further improved, and the energy of the laser beams can be effectively utilized to soften or melt the adhesive layers.

According to the fifth aspect of the invention, the first member that is a target member is laser-transmissive, and laser beams are applied through the first member to the double-sided adhesive tape. This can ensure that the adhesive layers of the double-sided adhesive tape are softened or melted, and can further improve the adhesive strength.

According to the sixth aspect of the invention, laser beams are applied through the laser non-transmissive second member to the double-sided adhesive tape. Thus, even if a laser absorbent is not mixed into the double-sided adhesive tape, the adhesive layers can be softened or melted, and the adhesive strength can be further improved.

### BRIEF DESCRIPTION OF THE FIGURES

FIG. 1 is an enlarged cross-sectional view of a double-sided adhesive tape according to an embodiment.

FIG. 2 is an exploded view of two members that are yet to be adhered together using a double-sided adhesive tape.

FIG. 3 is a diagram corresponding to FIG. 2 and illustrating the two members that have been adhered together.

FIG. 4 is a diagram corresponding to FIG. 2 and relating to each of examples.

FIG. 5 is a cross-sectional view taken along the line V-V in FIG. 4.

FIG. 6 is a plan view of a double-sided adhesive tape according to each example.

FIG. 7 is a diagram for explaining a procedure for an adhesive strength test.

FIG. 8 is a graph illustrating results of the adhesive strength test.

### DETAILED DESCRIPTION OF VARIOUS EMBODIMENTS

An embodiment of the present invention will now be described in detail with reference to the drawings. The following preferred embodiment is set forth merely for the purposes of examples in nature, and is not intended to limit the scope, applications, and use of the invention.

FIG. 1 is an enlarged cross-sectional view of a double-sided adhesive tape 1 according to the present invention. The double-sided adhesive tape 1 can be used to adhere, for example, members forming a flat panel display, an electric household appliance, an industrial electrical product, or any other product, members forming a household appliance, members forming a writing material, or members forming an automobile component. Only the double-sided adhesive tape 1 can be used to adhere such members, or such members can be temporarily adhered using the double-sided adhesive tape 1. In both of these cases, the double-sided adhesive tape 1 can be used.

The double-sided adhesive tape 1 can be used to adhere or temporarily adhere various members except the members described above, and the range of uses for the double-sided adhesive tape 1 is wide.

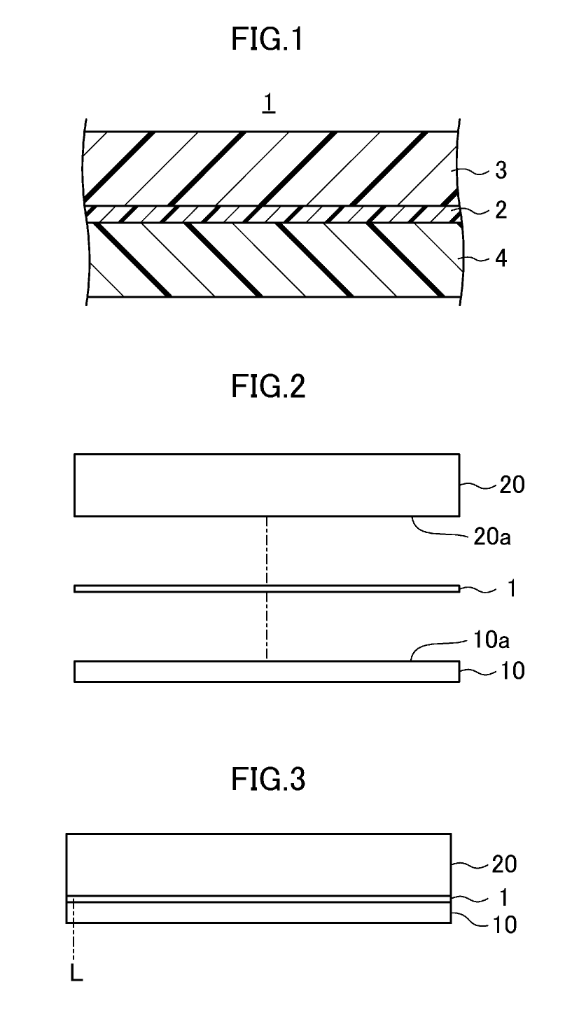

The double-sided adhesive tape 1 includes a substrate 2 made of a solid film, a first adhesive layer 3 placed on one surface of the substrate 2 and made of an adhesive composition, and a second adhesive layer 4 placed on the other surface of the substrate 2 and made of an adhesive composition. As illustrated in FIGS. 2 and 3, the double-sided adhesive tape 1 is used to adhere a first member 10 and a second member 20 together, and when the members are to be adhered together, the first and second adhesive layers 3 and 4 are softened or melted by being irradiated with laser beams L although described below in detail.

The substrate 2 is made of a material with high tear strength, i.e., high tensile breaking strength. The solid film is a film that does not contain air bubbles.

Examples of a material forming the substrate 2 include polyvinyl chloride (PVC), polycarbonate (PC), polyimide (PI), polypropylene (PP), polyethylene terephthalate (PET), polymethyl methacrylate (PMMA), polyamide (PA), and triacetal (TAC).

The thickness of the substrate 2 is preferably greater than or equal to 5 μm and equal to or less than 100 μm, more preferably greater than or equal to 10 μm and equal to or less than 50 μm.

The reason why the thickness of the substrate 2 is determined as described above will be described. The present inventors prototyped double-sided adhesive tapes 1 including respective substrates 2 having different thicknesses, and performed an experiment. The result of the experiment showed that when the thickness of the substrate 2 is less than 5 μm, the tensile breaking strength of the substrate 2 is not high enough unlike when the thickness of the substrate 2 is greater than or equal to 5 μm, and for this reason, the substrate 2 ruptures, and the double-sided adhesive tape 1 tears somewhere, for example, in a situation where the double-sided adhesive tape 1 bonded to the first member 10 is to be separated from the first member 10. This tear makes it difficult to separate the double-sided adhesive tape 1. This causes a problem principally when the first member 10 or any other members are discarded or recycled.

When the substrate 2 has a thickness greater than 100 μm, the entire thickness of the double-sided adhesive tape 1 is so large that the double-sided adhesive tape 1 is difficult to practically use. Furthermore, when the substrate 2 has a thickness greater than 100 μm, and a surface of the double-sided adhesive tape 1 near the first adhesive layer 3 (or the second adhesive layer 4) is irradiated with the laser beams L, the substrate 2 unfortunately functions to insulate heat, and heat is less likely to be transferred to the second adhesive layer 4 (or the first adhesive layer 3) remote from the irradiated surface of the double-sided adhesive tape 1 than when the substrate 2 has a thickness equal to or less than 100 μm. This causes inadequate melting or softening. When the substrate 2 has a thickness greater than 70 μm, it is difficult for the double-sided adhesive tape 1 to follow the shape of a bonding surface.

A surface of the substrate 2 near the first adhesive layer 3 and a surface thereof near the second adhesive layer 4 may be subjected to adhesion-promoting treatment for increasing adhesion to an adhesive composition. Examples of adhesion-promoting treatment include various types of easy adhesion treatment, corona discharge, flame treatment, and ultraviolet (UV) treatment.

The tensile breaking strength of the substrate 2 is set to greater than or equal to 80 MPa. The tensile breaking strength of the substrate 2 is preferably greater than or equal to 100 MPa.

The tensile breaking strength is obtained based on the result of a test conducted in accordance with Japanese industrial standards (JIS) K6251-1993. Specifically, the substrate 2 is punched into the shape of dumbbell No. 3, and a value obtained by dividing the breaking strength of the punched substrate 2 pulled at a tensile speed of 500 mm/minute by the cross-sectional area of the punched substrate 2 corresponds to the tensile breaking strength (see the following expression).

Tensile Breaking Strength (MPa)=Breaking Strength (N)/Cross-Sectional Area of Substrate 2 (mm2) where the cross-sectional area of the substrate 2 (mm2) is equal to the thickness of the substrate 2 (μm×10-3) multiplied by the width of the substrate 2 (5 mm).

When the tensile breaking strength of the substrate 2 is less than 80 MPa, the tensile strength of the substrate 2 is not high enough to, for example, separate the double-sided adhesive tape 1 bonded to the first member 10 from the first member 10 unlike when the tensile breaking strength of the substrate 2 is greater than or equal to 80 MPa. As a result, the substrate 2 ruptures, and the double-sided adhesive tape 1 tears somewhere. Even if increasing the adhesion of each of the first and second adhesive layers 3 and 4 increases the range of uses for the double-sided adhesive tape 1, the substrate 2 having a tensile breaking strength greater than or equal to 80 MPa can prevent the substrate 2 from being torn when the double-sided adhesive tape 1 is separated.

The density of the substrate 2 is preferably higher than or equal to 0.9 g·m3, more preferably higher than or equal to 1.0 g·m3. The upper limit of the density of the substrate 2 is, for example, 3.0 g·m3.

When the density of the substrate 2 is lower than 0.9 g·m3, the thermal conductivity of the substrate 2 is lower than when the density of the substrate 2 is higher than or equal to 0.9 g·m3, and for example, when a surface of the double-sided adhesive tape 1 near the first adhesive layer 3 is irradiated with laser beams L, heat is less likely to be transferred to the second adhesive layer 4 remote from the irradiated surface of the double-sided adhesive tape 1. Similar statements apply to a case where a surface of the double-sided adhesive tape 1 near the second adhesive layer 4 is irradiated with laser beams L.

When the density of the substrate 2 is higher than or equal to 0.9 g·m3, the substrate 2 is more resistant to water than when the density of the substrate 2 is lower than 0.9 g·m3. This makes it more difficult for water to penetrate the substrate 2 than in the conventional art, such as when foam of low specific gravity is used as the substrate or when nonwoven fabric is used as the substrate, and allows an adequate degree of water tightness to be stably obtained for a long time.

The thermal conductivity of the substrate 2 is preferably greater than or equal to 1×10-2 W/Mk. In a situation where the substrate 2 has a thermal conductivity lower than 1×10-2 W/Mk, when, for example, a surface of the double-sided adhesive tape 1 near the first adhesive layer 3 is irradiated with laser beams L, heat is less likely to be transferred to the second adhesive layer 4 remote from the irradiated surface of the double-sided adhesive tape 1. Similar statements apply to a case where a surface of the double-sided adhesive tape 1 near the second adhesive layer 4 is irradiated with laser beams L.

Furthermore, the substrate 2 has high density and adequate strength as described above, and is thus highly resilient and shape-retainable. For this reason, when the double-sided adhesive tape 1 is processed into an optional shape, the double-sided adhesive tape 1 can be stamped neatly, for example. In other words, the double-sided adhesive tape 1 has good stampability. Moreover, the double-sided adhesive tape 1 stamped into a predetermined shape is also highly resilient and shape-retainable, is thus easily bonded to the first and second members 10 and 20, and has good workability in bonding them. This facilitates automatically bonding the double-sided adhesive tape 1 to a target with a machine, i.e., mechanizing a bonding operation.

The adhesive compositions of the first and second adhesive layers 3 and 4 may be identical or different, and are each a thermoplastic elastomer adhesive or an acrylic adhesive. Thus, when the first and second adhesive layers 3 and 4 are heated, the adhesive compositions are softened, and melt with a further increase in temperature.

Examples of the thermoplastic elastomer include styrenic elastomers, such as a styrene-isoprene-styrene block copolymer (SIS), a styrene-butadiene-styrene block copolymer (SBS), and a styrene-ethylene-butylene-styrene block copolymer (SEBS), olefinic elastomers, polyester elastomers, vinyl chloride elastomers, polyamide elastomers, polybutadiene elastomers, isoprene elastomers, fluorocarbon elastomers, urethane elastomers, acrylic elastomers, and amorphous polyethylene (PE) elastomers.

Examples of the usable acrylic adhesive include an adhesive containing (meth)acrylic acid alkyl ester as an essential monomeric component (major monomeric component) and an acrylic polymer into which as needed, a copolymerizable monomer (e.g., a polar group-containing monomer or a multifunctional monomer) copolymerizable with (meth)acrylic acid alkyl ester is polymerized (or copolymerized) as a base polymer (base compound). Examples of a usable polymerization process include, but not limited to, processes known to those skilled in the art, such as UV polymerization, solution polymerization, and emulsion polymerization.

Examples of alkyl ester(meth)acrylate (alkyl ester(meth)acrylate having a linear or branched alkyl group) used as a major monomeric component of the acrylic polymer include C1-C20 alkyl ester(meth)acrylate, such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isoctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate, preferably C2-C14 alkyl ester(meth)acrylate, more preferably C2-C10 alkyl ester(meth)acrylate. Examples of a crosslinker used include an isocyanate crosslinker, an epoxy crosslinker, a chelate crosslinker, an azirine crosslinker, and a multifunctional acrylate crosslinker. Among them, an isocyanate crosslinker that is rich in reactivity with a (meth)acrylic copolymer, or a multifunctional acrylate crosslinker crosslinkable when exposed to light is preferably used.

Measures for adjusting the molecular weight of the adhesive composition within a suitable range include a process in which various additives are added to the adhesive composition.

Examples of a tackifier additive that tackifies the adhesive composition include a hydrogenated rosin ester, a hydrogenated terpene phenol, a polar saturated aliphatic hydrocarbon resin, and an acryl copolymer. Among them, a transparent polar saturated aliphatic hydrocarbon resin or a transparent hydrogenated terpene phenol is preferably used.

A laser absorbent absorbing laser beams L is mixed into the adhesive composition. Examples of the laser absorbent include an organic dye, an organic pigment, a commercial laser absorbent, and carbon black. The laser beam absorbency (absorptance) can be optionally determined depending on the type of the laser absorbent or the content of the laser absorbent.

For example, unless the performance of the adhesive composition is inhibited, an antioxidant, a filler, and a thickener may be added to the adhesive composition as necessary.

The thicknesses of the first and second adhesive layers 3 and 4 may be equal to each other, or may be both determined to be greater than or equal to 70 μm. Specifically, the thicknesses of the first and second adhesive layers 3 and 4 are preferably set within the range from 70 μm to 200 μm, and are more preferably set within the range from 90 μm to 150 μm.

One of the reasons for this is that when the first and second adhesive layers 3 and 4 have a thickness less than 70 μm, the first and second adhesive layers 3 and 4 melted or softened by being irradiated with laser beams L are less likely to be deformed to adequately follow uneven bonding surfaces 10a and 20a of the first and second members 10 and 20 than when the first and second adhesive layers 3 and 4 have a thickness greater than or equal to 70 μm. Unless the first and second adhesive layers 3 and 4 follow the bonding surfaces 10a and 20a, the adhesive strength and water tightness are less likely to be both obtained.

Another one of the reasons is that when the first and second adhesive layers 3 and 4 have a thickness less than 70 μm, a cohesive failure easily occurs under an impact caused, for example, by dropping the first and second members 10 and 20 that have been adhered together. Specifically, when the first and second members 10 and 20 are subjected to impact, stress is generated in the first and second adhesive layers 3 and 4 of the double-sided adhesive tape 1 at the junction between the first and second members 10 and 20. When the first and second adhesive layers 3 and 4 have a thickness less than 70 μm, the stress generated in the first and second adhesive layers 3 and 4 is less likely to be spread and reduced, and a cohesive failure easily occurs. In contrast, when the first and second adhesive layers 3 and 4 have a thickness greater than or equal to 70 μm, the stress is easily reduced by being spread along the thicknesses of the first and second adhesive layers 3 and 4, and a cohesive failure is less likely to occur.

When the first and second adhesive layers 3 and 4 have a thickness greater than 200 μm, the double-sided adhesive tape 1 is so thick that for example, when a surface of the double-sided adhesive tape 1 near the first adhesive layer 3 is irradiated with laser beams L, heat is less likely to be transferred to the entire second adhesive layer 4 remote from the irradiated surface of the double-sided adhesive tape 1. When the first and second adhesive layers 3 and 4 have a thickness greater than 200 μm, the double-sided adhesive tape 1 is so thick that the double-sided adhesive tape 1 is difficult to practically use and to bond to a bent surface along the bent surface.

Next, a procedure for manufacturing a double-sided adhesive tape 1 will be described. A substrate 2 is prepared, and both surfaces of the substrate 2 are coated with the adhesive composition. Examples of a usable coater for coating the substrate 2 with the adhesive composition include a comma coater, a roll coater, a die coater, a flow coater, and a hot melt coater. Since, in this embodiment, the first and second adhesive layers 3 and 4 have a thickness greater than or equal to 70 μm, a process in which any one of the above-described coaters is used is preferably used, whereas a process in which a coater except the above-described coaters is used may be used as long as the process can ensure the thickness. The process for coating the substrate 2 with the adhesive composition should not be limited to the processes in which the coaters are used, and for example, a release film can be coated with an adhesive composition, and the adhesive composition can be transferred to the substrate 2 to form the first and second adhesive layers 3 and 4.

Alternatively, the substrate 2 can be coated with an adhesive composition dissolved in a solvent or an ultraviolet-curable adhesive composition, and such an adhesive composition can be dried to form the first and second adhesive layers 3 and 4. To dry the adhesive composition, a hot air oven, for example, can be used, and if the adhesive composition is to be dried by ultraviolet irradiation, an ultraviolet irradiator can be used.

Next, the first and second members 10 and 20 will be described. The shape and size of each of the first and second members 10 and 20 should not be specifically limited, and the material thereof may be a resin or metal.

Examples of the resin that may form the first and second members 10 and 20 include poly(methyl methacrylate) (PMMA), polycarbonate (PC), polyvinyl chloride, polyethylene terephthalate (PET), and poly styrene (PS), which are transparent, and polypropylene (PP), polyacetal such as poly-oxymethylene (POM), polyamide (PA), polybutylene terephthalate (PBT), polyphenylene sulfide (PPS), and an acrylonitrile-butadiene-styrene (ABS) copolymer, which are white-opaque and have high crystallinity. If the first and second members 10 and 20 are made of a resin, the resin may be coated with a thermosetting ink or an ultraviolet-curable ink, or may be coated in various manners. Alternatively, the resin may have, for example, a surface on which metal or a metallic oxide is deposited, or a plated surface.

Examples of the metal that may form the first and second members 10 and 20 include steel, zinc, aluminum (Al), magnesium (Mg), and stainless steel (SUS). The first and second members 10 and 20 may be made of, for example, glass or ceramic.

The first and second members 10 and 20 may be made of different materials or an identical material.

Next, a procedure for adhering the first and second members 10 and 20 together using the double-sided adhesive tape 1 will be described. In this embodiment, the first member 10 is made of a laser-transmissive material through which laser beams L can pass. Specifically, the first member 10 is transparent, and the “laser-transmissive material” means a material through which laser beams L serving as a heat source pass while being hardly reflected and absorbed or a material which does not melt even when some of laser beams L pass therethrough and/or are reflected therefrom and through which the other ones of the laser beams L can pass. Examples of the “laser-transmissive material” include a material through which all of the laser beams L can pass.

While, in this embodiment, the second member 20 is made of a laser non-transmissive material, the second member 20 may be laser-transmissive. The “laser non-transmissive material” means a laser-absorbent material that absorbs laser beams L, i.e., a material that even when some of laser beams L pass therethrough or are reflected therefrom, absorbs the remaining ones thereof. Examples of the “laser non-transmissive material” include a material absorbing all of the laser beams L.

First, the first adhesive layer 3 of the double-sided adhesive tape 1 is bonded to the bonding surface 10a of the first member 10, and the second adhesive layer 4 is then bonded to the bonding surface 20a of the second member 20. The first adhesive layer 3 of the double-sided adhesive tape 1 may be bonded to the bonding surface 20a of the second member 20, and the second adhesive layer 4 may be then bonded to the bonding surface 10a of the first member 10.

Thereafter, laser beams L are applied to the first member 10. The laser beams L pass through the first member 10, and reach the double-sided adhesive tape 1. Some of the laser beams L are absorbed by the first adhesive layer 3, and the remaining ones thereof are absorbed by the substrate 2 or the second adhesive layer 4.

The first adhesive layer 3 that has absorbed the some of the laser beams L generates heat so as to be softened or to be melted. Whether the first adhesive layer 3 is softened or melted can be selected depending on, for example, the power of the laser beams L or the scanning speed. The softened or melted first adhesive layer 3 is deformed along the bonding surface 10a of the first member 10. In this case, the first adhesive layer 3, which is determined to have a thickness of greater than or equal to 70 μm, is deformed to follow the shape of the bonding surface 10a of the first member 10 even when the bonding surface 10a is uneven. This ensures an adequate area of adhesion.

Heat of the first adhesive layer 3 is transferred to the substrate 2, and is then transferred to the second adhesive layer 4. In this case, since the substrate 2 is a solid film and has a thermal conductivity greater than or equal to 1×10-2 W/Mk, heat of the first adhesive layer 3 easily reaches the second adhesive layer 4. Thus, the second adhesive layer 4 is also softened or melted so as to be deformed along the bonding surface 20a of the second member 20. The melting point of the substrate 2 is determined to prevent the substrate 2 from melting at a temperature at which the first adhesive layer 3 melts.

After irradiated with the laser beams L, the double-sided adhesive tape 1 is cooled to about room temperature to obtain an intended adhesive strength.

When the first and second members 10 and 20 adhered together are, for example, dropped, and are subjected to impact, stress is spread along the thicknesses of the first and second adhesive layers 3 and 4, which are greater than or equal to 70 μm, and is thus reduced. Furthermore, since the tensile breaking strength of the substrate 2 is higher than or equal to 80 MPa, rupture in the substrate 2 is reduced. The spreading of stress and the reduction in rupture prevent the first and second members 10 and 20 from being separated from each other.

When the first and second members 10 and 20 need to be separated from each other so as to be discarded or recycled, the first and second members 10 and 20 are separated from each other by applying strong forces to the first and second members 10 and 20. A force is applied in a direction of separation of one of the first and second members 10 and 20 by grasping the double-sided adhesive tape 1 adhered to the one of the first and second members 10 and 20, thereby easily removing the double-sided adhesive tape 1 without a rupture of the substrate 2.

As described above, according to this embodiment, the first and second adhesive layers 3 and 4 having a thickness greater than or equal to 70 μm provide an adequate adhesive strength even with the bonding surfaces 10a and 20a uneven, and can ensure a necessary degree of water tightness. Furthermore, since the substrate 2 is made of a solid film and has a tensile breaking strength higher than or equal to 80 MPa, the double-sided adhesive tape 1 that needs to be separated is prevented from tearing somewhere, and can be thus easily removed.

A laser absorbent is mixed into the first and second adhesive layers 3 and 4, and the adhesive layers 3 and 4 are thus softened or melted by heat. This can further improve the adhesive strength. Furthermore, the substrate 2 is a solid film, and thus has a high thermal conductivity. This facilitates transferring heat generated by the laser beams L to both the adhesive layers 3 and 4. Thus, the energy of the laser beams L can be effectively utilized to soften or melt the adhesive layers.

The laser beams L are applied to the laser-transmissive first member 10. This can ensure that the first and second adhesive layers 3 and 4 of the double-sided adhesive tape 1 are softened or melted, and can further improve the adhesive strength.

While, in the embodiment, a laser absorbent is mixed into the first and second adhesive layers 3 and 4, a laser absorbent may be mixed into a material forming the substrate 2 without mixing a laser absorbent into the first and second adhesive layers 3 and 4. Thus, the substrate 2 generates heat by being irradiated with the laser beams L, and the heat of the substrate 2 is transferred to the first and second adhesive layers 3 and 4.

The laser beams L may be applied to the laser non-transmissive second member 20. In this case, the second member 20 generates heat by being irradiated with the laser beams L, and the heat of the second member 20 is transferred to the first and second adhesive layers 3 and 4 to soften or melt the first and second adhesive layers 3 and 4. Thus, even when a laser absorbent is not mixed into the double-sided adhesive tape 1, the first and second adhesive layers 3 and 4 can be softened or melted. Alternatively, a laser absorbent or a substance having high thermal conductivity, such as carbon black, metal powder, or metallic oxide powder, may be appropriately dispersed in the double-sided adhesive tape 1. This can further increase the thermal conductivities of the adhesive layers 3 and 4 themselves, and enables efficient softening or melting of the adhesive layers 3 and 4.

While, in the embodiment, the first and second adhesive layers 3 and 4 are made of an identical adhesive composition, the first and second adhesive layers 3 and 4 may be made of different adhesive compositions. The first and second adhesive layers 3 and 4 may have different thicknesses.

Examples of the present invention will be described.

<Preparation of Double-Sided Adhesive Tape>

A substrate 2 is a PET film (COSMOSHINE A4300 manufactured by Toyobo Co., Ltd.). The substrate 2 has a thickness of 38 μm. Both surfaces of the substrate 2 are subjected to easy adhesion treatment. Examples of a process for performing easy adhesion treatment include a process in which the substrate 2 is coated with a highly adhesive thermoplastic resin before biaxial stretching, and is then stretched, and a process in which a stretched substrate 2 is directly coated with a highly adhesive thermoplastic resin. The tensile breaking strength of the substrate 2 was set at 170 MPa.

The first and second adhesive layers 3 and 4 are made of an identical adhesive composition. The adhesive composition is a thermoplastic elastomer adhesive, and was obtained in the following manner. First, the adhesive composition was obtained in the form of paint. Specifically, 100 g of SIS (TR-5002 manufactured by JSC Corporation), 100 g of Clearon (P-105 manufactured by YASUHARA CHEMICAL CO., LTD.) serving as a tackifier, and 0.1 g of carbon black serving as a laser absorbent were dispersed and dissolved in 300 g of toluene. The solid content of the resultant paint was about 40%.

The paint was applied, using an applicator, onto a PET film (PET38GS manufactured by Lintec Corporation) subjected to release treatment. The PET film has a thickness of 38 μm. The paint was dried to form a releasable adhesive layer on the PET film. The thickness of the adhesive layer on the PET film can be optionally determined by the thickness of the paint applied thereon.

The adhesive layer formed on the PET film was transferred to both surfaces of the substrate 2 to obtain the first and second adhesive layers 3 and 4.

A total of six double-sided adhesive tapes having respective first adhesive layers 3 with different thicknesses and respective second adhesive layers 4 with different thicknesses were prepared.

TABLE 1

| | First | Second | Third | | | |
|---|---|---|---|---|---|---|
| | Comparative | Comparative | Comparative | First | Second | Third |
| | Example | Example | Example | Example | Example | Example |
| Thickness of | 30 | 50 | 110 | 70 | 90 | 110 |
| First Adhesive | | | | | | |
| Layer (μm) | | | | | | |
| Thickness of | 30 | 50 | 50 | 70 | 90 | 110 |
| Second | | | | | | |
| Adhesive | | | | | | |
| Layer (μm) | | | | | | |

In each of first and second comparative examples, the first and second adhesive layers 3 and 4 have a thickness less than 70 μm, and in a third comparative example, while the first adhesive layer 3 has a thickness greater than 70 μm, the second adhesive layer 4 has a thickness less than 70 μm.

In each of first through third examples, the first and second adhesive layers 3 and 4 have a thickness greater than or equal to 70 μm.

<First and Second Members>

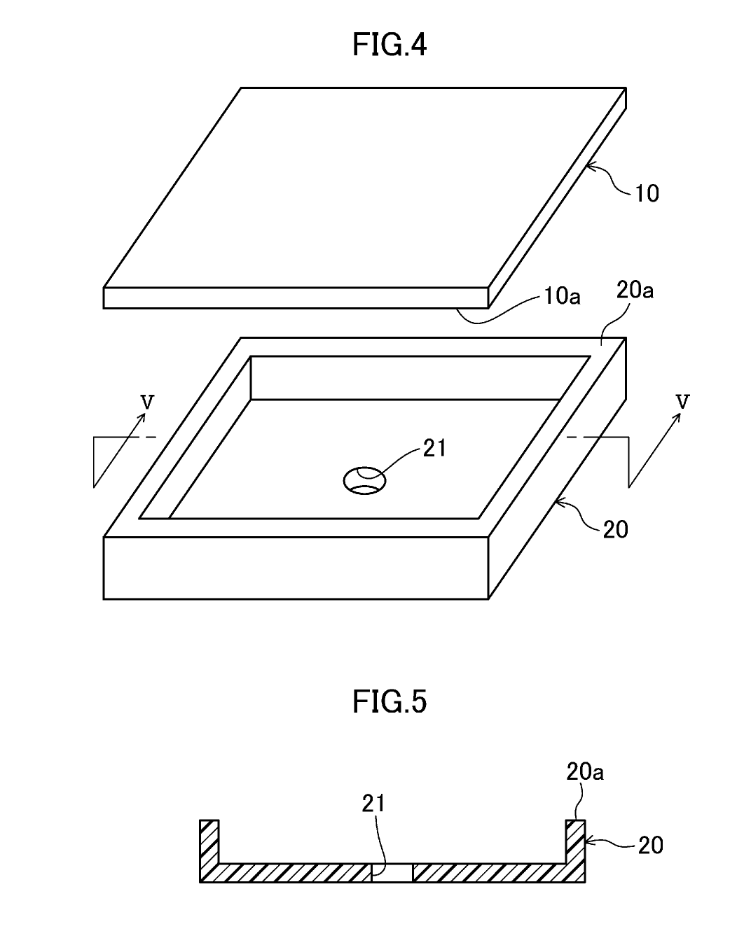

A first member 10 is a transparent acrylic board as illustrated in FIG. 4, and is laser-transmissive. A second member 20 is a box-like container made of nylon 66 as illustrated in FIGS. 4 and 5, and is laser non-transmissive. One side of the second member 20 is open, and the first member 10 covers the open side.

For more details, the first member 10 is a 50-mm square board, and has a thickness of 2 mm. Wall portions of the second member 20 each have a thickness of 2 mm. When the second member 20 is seen from its open side, the second member 20 has external dimensions of 50 mm×50 mm, which correspond to the external dimensions of the first member 10. The second member 20 has a depth of 3 mm. A central portion of the second member 20 has a through hole 21 having a diameter of 15 mm.

A double-sided adhesive tape 1 is bonded to a peripheral portion of a bonding surface 10a of the first member 10 (a surface thereof near the second member 20), and forms a closed shape. In other words, the double-sided adhesive tape 1 is bonded to a distal end surface of a peripheral portion of the second member 20 being a bonding surface 20a of the second member 20 along the entire perimeter of the second member 20.

<Adhesion Process Step>

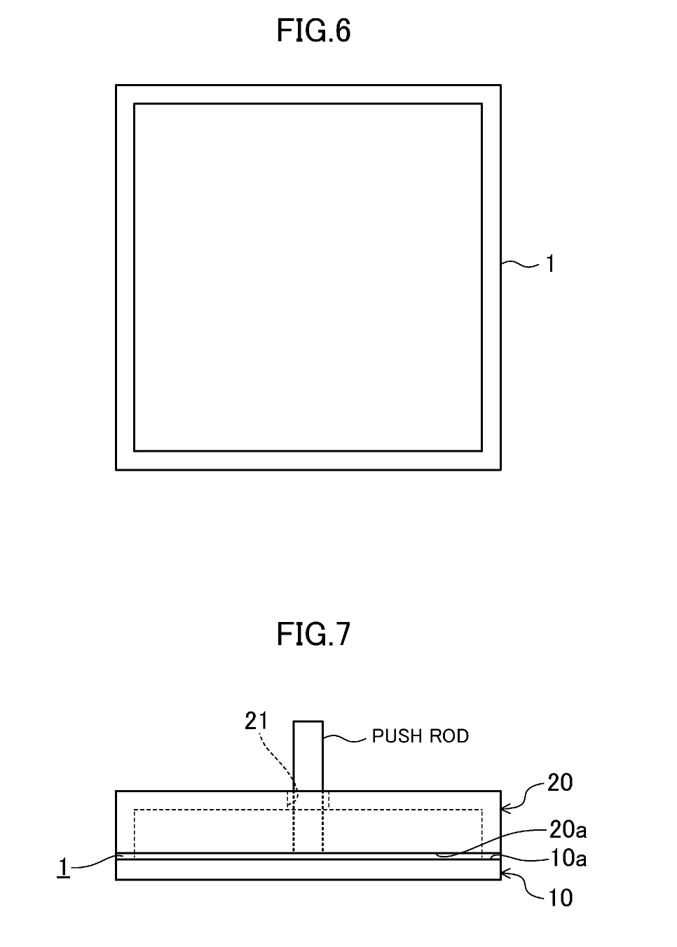

The double-sided adhesive tape 1 was stamped into a closed shape as illustrated in FIG. 6. The first adhesive layer 3 of the double-sided adhesive tape 1 was bonded to the bonding surface 10a of the first member 10, and the first member 10 was located to cover the open side of the second member 20. The second adhesive layer 4 was bonded to the bonding surface 20a of the second member 20.

Thereafter, the first and second members 10 and 20 were clamped along a direction of adhesion of the first and second members 10 and 20 (along the thickness of the first member 10) with a clamping device (not shown). The pressure at which the first and second members 10 and 20 were clamped was 0.4 MPa.

Thereafter, laser beams L were applied to a peripheral portion of the first member 10 along the entire perimeter of an area where the double-sided adhesive tape 1 is bonded to the first member 10. The laser beams L correspond to a semiconductor laser with an output wavelength of 940 nm. The power of the laser beams L was 3 W, and the scanning speed was 1.2 m/minute. After the application of the laser beams L, the double-sided adhesive tape 1 was left until the temperature of the double-sided adhesive tape 1 reached room temperature.

<Adhesive Strength Test>

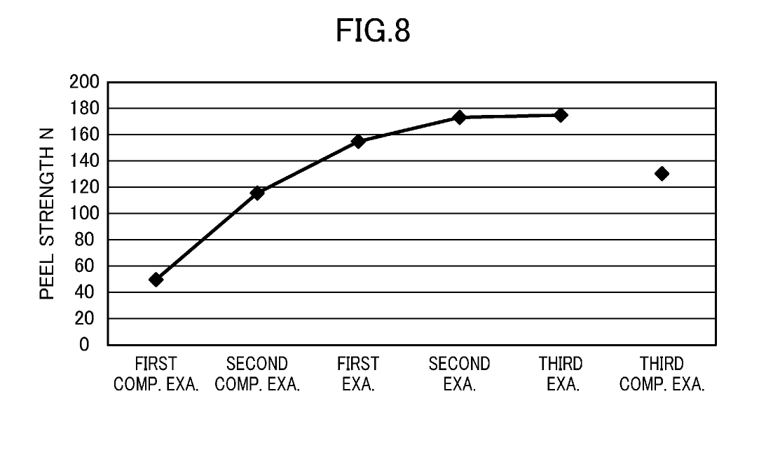

In an adhesive strength test, as illustrated in FIG. 7, the second member 20 was fixed, and a push rod was inserted through the through hole 21 of the second member 20 to push the first member 10 in a direction in which the first member 10 is separated from the second member 20 (downward in FIG. 7). The push rod has a diameter of 12 mm, and a front end surface of the push rod was brought into contact with a central portion of the first member 10. The push rod was moved at a speed of 5 mm/minute in the direction in which the first member 10 is separated from the second member 20, and the force required to separate the first member 10 from the second member 20 was measured. The measurement results are illustrated in FIG. 8.

Since, in each of the first and second comparative examples, the first and second adhesive layers 3 and 4 have a thickness less than 70 μm, the adhesive strength was as low as a value less than 120 N. Since, in the third comparative example, while the first adhesive layer 3 has a thickness greater than 70 μm, the second adhesive layer 4 has a thickness less than 70 μm, a cohesive failure occurred in the second adhesive layer 4, and the adhesive strength was as low as a value less than 130 N. In other words, if one of the first and second adhesive layers 3 and 4 is less than 70 μm, the adhesive strength decreases.

In contrast, since, in each of the first through third examples, the first and second adhesive layers 3 and 4 have a thickness greater than or equal to 70 μm, the adhesive strength was as high as a value greater than or equal to 150 N. In particular, in the second example, the adhesive strength was extremely high, such as greater than or equal to 170 N. The difference in adhesive strength between the second and third examples is not as large as the difference in adhesive strength between the first and second examples. Thus, even if the first and second adhesive layers 3 and 4 have a thickness greater than 110 μm, the degree of increase in adhesive strength is low. For this reason, the maximum thickness of each of the first and second adhesive layers 3 and 4 is preferably about 110 μm.

<Water Tightness Test>

In a water tightness test, the first member 10 used in the adhesive strength test was used, and a second member 20 that does not have a through hole 21 was used. The first and second members 10 and 20 were adhered together, the adhered first and second members 10 and 20 were immersed in water to a depth of 1 m for 24 hours, and whether or not water entered the interior of the second member 20 was observed.

The double-sided adhesive tape 1 of the second example was used. When laser beams L were applied to the first member 10 to adhere the first and second members 10 and 20 together, the first and second adhesive layers 3 and 4 were deformed to follow the bonding surface 10a of the first member 10 and the bonding surface 20a of the second member 20, respectively. As a result of observing ten samples, water did not enter the interior of any one of the samples.

<Ease of Separation>

The second adhesive layer 4 of the double-sided adhesive tape 1 was bonded to the bonding surface 20a of the second member 20. A release film was previously bonded to the first adhesive layer 3 of the double-sided adhesive tape 1, and the first member 10 was pressed against the release film. The first and second members 10 and 20 were clamped as described in the adhesion process step, and the laser beams L were applied to the first member 10.

After the first and second members 10 and 20 were cooled to room temperature, the second member 20 was separated from the first member 10, the release film was removed, and an end of the double-sided adhesive tape 1 was grasped and firmly tugged in a direction of separation of the double-sided adhesive tape 1 from the second member 20. Consequently, the double-sided adhesive tape 1 was successfully separated from the second member 20 without tearing somewhere. The reason for this is that the tensile breaking strength of the substrate 2 was set to greater than or equal to 80 MPa.

### Another Example

Each of the tests was conducted using an acrylic adhesive different from the adhesive composition as an adhesive composition. Specifically, 70 g of butyl acrylate, 25 g of methyl acrylate, 5 g of acrylic acid were dissolved in 150 g of toluene to obtain a solution, 1.2 g of trimethylolpropane-tolylene diisocyanate was added to 100 g of the solution, and the trimethylolpropane-tolylene diisocyanate and the solution were mixed together to obtain paint. The paint was applied onto a PET film subjected to release treatment to obtain an acrylic adhesive.

First and second adhesive layers 3 and 4 containing the acrylic adhesive were formed, and each have a thickness similar to that of a corresponding one of the first and second adhesive layers 3 and 4 of each of the first and second comparative examples and the first through third examples. Also in this case, if the first and second adhesive layers 3 and 4 have a thickness greater than or equal to 70 μm, the adhesive strength in the adhesive strength test was greater than or equal to 150 N, and the water tightness was successfully ensured.

### Another Comparative Example

Each of the tests was conducted using a commercial double-sided adhesive tape (VHB acrylic foam structural adhesive tape Y-4914 manufactured by Sumitomo 3M Limited). A substrate of the double-sided adhesive tape is a foamed material, and the tensile breaking strength of the substrate was 20 MPa. When the first and second members 10 and 20 are adhered together, the first and second members 10 and 20 were clamped with a clamping device, and laser beams L were not applied to the first member 10.

As a result of the adhesive strength test, the adhesive strength was 80 N, which was much lower than that of each of the first through third examples. The water tightness test showed that water entered the interiors of all of ten samples. The reason for this is that adhesive layers did not follow corresponding uneven bonding surfaces.

While an end of the double-sided adhesive tape was grasped to remove the double-sided adhesive tape, the double-sided adhesive tape was stretched and tore somewhere, and the double-sided adhesive tape was difficult to remove with the fingers. The reason for this is that a foamed material having a low tensile breaking strength was used as the substrate.

As described above, the present invention can be used to adhere, for example, members forming a flat panel display, an electric household appliance, an industrial electrical product, and any other product, members forming a household appliance, or members forming a writing material.

### DESCRIPTION OF REFERENCE CHARACTERS

Double-Sided Adhesive Tape
2 Substrate
3 First Adhesive Layer
4 Second Adhesive Layer
10 First Member
10a Bonding Surface
20 Second Member
20a Bonding Surface

1-6. (canceled)

7. A double-sided adhesive tape comprising:
a substrate comprising surfaces on each of which an adhesive layer made of an adhesive composition is provided, wherein:
the adhesive composition is a thermoplastic elastomer adhesive or an acrylic adhesive;
a thickness of the adhesive layer is greater than or equal to 70 μm;
the substrate is a solid film; and
a tensile breaking strength of the substrate is greater than or equal to 80 MPa.

8. The double-sided adhesive tape of claim 7, wherein:
a laser absorbent is mixed into at least one of the adhesive layers or the substrate; and
the adhesive layers are at least one of softened or melted by heat.

9. A method for adhering first and second members together using a double-sided adhesive tape including a substrate having surfaces on each of which an adhesive layer made of an adhesive composition is provided, the method comprising the steps of:
using at least one of a thermoplastic elastomer adhesive or an acrylic adhesive as the adhesive composition;
setting a thickness of each adhesive layer to greater than or equal to 70 μm;
using a solid film as the substrate;
setting a tensile breaking strength of the substrate to greater than or equal to 80 MPa;
bonding one of the adhesive layers of the double-sided adhesive tape to a bonding surface of the first member; and
bonding the other one of the adhesive layers to a bonding surface of the second member.

10. The method of claim 9, wherein:
a laser absorbent is mixed into at least one of the adhesive layers or the substrate;
the adhesive layers are softened or melted by heat;
the double-sided adhesive tape is irradiated with laser beams to at least one of soften or melt the adhesive layers so that the first and second members are adhered together.

11. The method of claim 10, wherein:
the first member is transmissive to laser beams; and
laser beams are applied through the first member toward the double-sided adhesive tape.

12. The method of claim 9, wherein:
the second member is non-transmissive to laser beams; and
laser beams are applied through the second member toward the double-sided adhesive tape.
